(19) United States
(12) Patent Application Publication
(10) Pub. No.: US 2012/0267001 A1
(43) Pub. Date: Oct. 25, 2012

(54) HEAT RESISTANT TITANIUM ALLOY MATERIAL FOR EXHAUST SYSTEM PART USE EXCELLENT IN OXIDATION RESISTANCE, METHOD OF PRODUCTION OF HEAT RESISTANT TITANIUM ALLOY MATERIAL FOR EXHAUST SYSTEM PART USE EXCELLENT IN OXIDATION RESISTANCE, AND EXHAUST SYSTEM

(76) Inventors: Hiroaki Otsuka, Chiyoda-ku (JP); Hideki Fujii, Chiyoda-ku (JP)

(21) Appl. No.: 13/516,886

(22) PCT Filed: Dec. 16, 2010
(86) PCT No.: PCT/JP2010/073257

§ 371 Date: Jun. 18, 2012

(30) Foreign Application Priority Data
Dec. 28, 2009 (JP) 2009-297594

(51) Int. Cl. C22C 14/00; F16L 9/00; C22F 1/18

(52) U.S. Cl. 138/177; 420/417; 148/670

(57) ABSTRACT

A titanium alloy material for exhaust system parts which is excellent in oxidation resistance able to be used for an exhaust manifold, exhaust pipe, catalyst device, muffler, or other part characterized by containing, by mass %, Cu: 0.5 to 1.5%, Sn: 0.5 to 1.5%, Si: 0.1% to 0.6%, and O: 0.1% or less, a total of the contents of Cu and Sn being 1.4 to 2.7%, and having a balance of Ti and unavoidable impurities. A titanium alloy material for exhaust system parts which is excellent in oxidation resistance and cold workability.

### TECHNICAL FIELD

The present invention relates to a titanium material used for an exhaust system for four-wheeled vehicles, motorcycles, and other automobiles and relates as well as to a titanium alloy material which is light in weight and excellent in corrosion resistance, workability, heat resistance, and oxidation resistance able to be used for a main muffler of course and also an exhaust manifold, exhaust pipe, catalyst device, muffler, or other location which is temporarily exposed to a high temperature of near 800° C. and where heat resistance and oxidation resistance are particularly required and to an exhaust system using this titanium alloy material.

### BACKGROUND ART

Titanium materials are light in weight, yet high in strength and excellent in corrosion resistance, so are being used even for the exhaust systems of automobiles. The combustion gas discharged from the engines of automobiles and motorcycles is collected at an exhaust manifold and discharged by an exhaust pipe from an exhaust outlet at the rear of a vehicle.

An exhaust pipe is formed split into several segments to enable insertion of a catalyst device which carries or is coated with a catalyst or of a muffler in the middle. In this Description, the entire system from the exhaust manifold to the exhaust pipe and exhaust outlet will be called an “exhaust system”.

For the materials for such an exhaust system, in place of the conventional stainless steel material, from the viewpoint of reducing the weight of the vehicle, JIS class 2 commercially pure titanium material is being used—mostly for motorcycles. Furthermore, recently, in place of the JIS class 2 commercially pure titanium material, a titanium alloy with a higher heat resistance is used. Further, in recent years, to remove harmful ingredients from exhaust gas, mufflers which carry catalysts which are used at a high temperature are also being used.

The temperature of exhaust gas sometimes exceeds 700° C. and temporarily even reaches 800° C. For this reason, in materials which are used for exhaust systems, indicators such as the strength at a temperature around 800° C., oxidation resistance, creep speed at 600 to 700° C., and other aspects of high temperature heat resistance are stressed.

In terms of high temperature strength, a Ti-3Al-2.5V alloy or a Ti-6Al-4V alloy is excellent.

In PLT 1, a titanium alloy which is excellent in cold workability and high temperature strength is proposed.

In PLT 2, a titanium alloy which is excellent in oxidation resistance and corrosion resistance is proposed.

In PLT 3, a heat resistant titanium alloy sheet which is excellent in cold workability and a method of production of the same are proposed.

In PLT 4, a titanium alloy with a surface covered by a protective film is proposed.

In PLT 5, a titanium alloy which is excellent in high temperature strength at 700° C. and oxidation resistance at 800° C. is proposed.

### CITATIONS LIST

### Patent Literature

PLT 1: Japanese Patent Publication (A) No. 2001-234266

PLT 2: Japanese Patent Publication (A) No. 2005-290548

PLT 3: Japanese Patent Publication (A) No. 2005-298970

PLT 4: Japanese Patent Publication (A) No. 2007-100171

PLT 5: Japanese Patent Publication (A) No. 2009-68026

### SUMMARY OF INVENTION

### Technical Problem

Ti-3Al-2.5V alloy is too high in strength at room temperature and is poor in formability. Further, the increase in oxidation at a temperature near 700° C. is large. Furthermore, cold rolling is possible, but edge cracking easily occurs and intermediate annealing has to be applied several times during the cold rolling, so the processing cost rises.

Ti-6Al-4V alloy is difficult to cold work and cannot be made into sheet, so is unsuitable as a material for exhaust systems.

The titanium alloy containing 0.5 to 2.3 mass % of Al which is described in PLT 1 is large in increase of oxidation near 700° C. and, further, is remarkable in peeling of scale. Therefore, the surface after peeling of scale is again oxidized and that scale is again peeled off in a repeated process. As a result, unevenness and remarkable reduction of thickness occur, so use at locations becoming high in temperature is difficult.

PLT 2 discloses a titanium alloy which contains, by mass %, Al: 0.30 to 1.50%, Si: 0.10 to 1.0%, and Nb: 0.1 to 0.5%. This titanium alloy is poor in cold workability, in particular stretch-expansion formability where working occurs in a direction in which the sheet thickness is reduced.

PLT 3 discloses a titanium alloy which contains, by mass %, Cu: 0.3 to 1.8%, O: 0.18% or less, Fe: 0.30% or less, and, as needed, furthermore, one or more of Sn, Zr, Mo, Nb, and Cr in a total of 0.3 to 1.5% and has a balance of Ti and less than 0.3% of impurity elements. This titanium alloy is not sufficient in oxidation resistance at 800° C.

PLT 4 proposes a Ti—Cu alloy and Ti—Cu—Nb alloy sheet which are coated with a protective film containing, by mass %, Si: 15 to 55%, C: 10 to 45%, and Al: 20 to 60%. When coating a protective film on a titanium alloy sheet, there is the problem that if working the sheet after coating it, the protective film will peel off. Further, if coating the protective film after working the sheet, there are the problems that coating to a uniform thickness will not be possible and locations will be formed where the oxidation resistance becomes insufficient.

PLT 5 proposes an alloy which contains, by mass %, Cu: 0.5 to 1.8%, Si: 0.1 to 0.6%, and O: 0.1% or less and, as needed, Nb: 0.1 to 1.0% and has a balance of Ti and unavoidable impurities. This alloy is not sufficient in high temperature strength at 800° C.

In view of the above situation, the present invention has as its task the provision of a heat resistant titanium alloy material for exhaust system parts which is excellent in high temperature strength and oxidation resistance able to be used for exhaust manifolds, exhaust pipes, catalyst devices, mufflers, and other locations which are temporarily exposed to high temperatures of 800° C. or higher and of an exhaust system using that alloy material.

### Solution to Problem

The inventors investigated the effects of increase of the amount of Cu for improving the high temperature strength for a Ti—Cu—Si ternary titanium alloy containing Si—an element which contributes to improvement of the oxidation resistance at a high temperature. As a result, it was learned that if making the amount of Cu increase, Ti₂Cu precipitates easier, so the cold workability declines and that to avoid this, heat treatment at a high temperature becomes necessary.

The inventors engaged in further studies and as a result discovered that even if keeping the amount of Cu down, addition of Sn enables the precipitation of Ti₂Cu to be suppressed even at a relatively low heat treatment temperature and enables the high temperature strength to be improved. This is believed to be because Sn forms a sufficient amount of solid solution with respect to titanium and, further, intermetallic compounds with titanium do not precipitate.

Further, they learned that by keeping the content of oxygen low, a cold workability on a par with pure titanium can be secured.

Furthermore, the inventors discovered that by adding Nb to Ti—Cu—Sn—Si alloy, the oxidation resistance in the temperature region exceeding 800° C. is remarkably improved.

The present invention was made based on such discoveries and has as its gist the following.

(1) A heat resistant titanium alloy material for exhaust system parts which is excellent in oxidation resistance characterized by containing, by mass %, Cu: 0.5 to 1.5%, Sn: 0.5 to 1.5%, Si: over 0.1% to not more than 0.6%, and O: 0.1% or less, a total of the contents of Cu and Sn being 1.4 to 2.7%, and having a balance of Ti and unavoidable impurities (hereinafter referred to as “the present invention (1)”).

(2) A heat resistant titanium alloy material for exhaust system parts which is excellent in oxidation resistance of (1) characterized by further containing, by mass %, Nb: 0.1 to 1.0% (hereinafter referred to as “the present invention (2)”).

(3) A method of production of a heat resistant titanium alloy sheet for exhaust system parts which is excellent in oxidation resistance characterized by hot rolling a titanium alloy material of the above (1) or (2), then cold rolling it, and after that annealing it at 750 to 830° C. (hereinafter referred to as “the present invention (3)”).

(4) A method of production of a heat resistant titanium alloy sheet for exhaust system parts which is excellent in oxidation resistance characterized by hot rolling a titanium alloy material of the above (1) or (2), then annealing it at 750 to 830° C., next cold rolling it, and after that annealing it at 650 to 750° C. (hereinafter referred to as “the present invention (4)”).

(5) An exhaust system provided with an exhaust manifold, exhaust pipe, catalyst device, and muffler, the exhaust system characterized by using a heat resistant titanium alloy material for exhaust system parts which is excellent in oxidation resistance of the above (1) or (2) for one or more of the exhaust manifold, exhaust pipe, catalyst device, and muffler (hereinafter referred to as “the present invention (5)”).

### Advantageous Effects of Invention

According to the present invention, it is possible to obtain a heat resistant titanium alloy material for exhaust system parts which has sufficient strength at a high temperature, which is superior in oxidation resistance, and which is excellent in cold workability and to obtain an exhaust system using this alloy material.

### DESCRIPTION OF EMBODIMENTS

Below, “%” means “mass %”.

Cu, one of the alloy elements in the present invention, forms a solid solution in titanium up to 2.1% at a high temperature of 790° C. In a titanium alloy in which Cu forms a solid solution, Ti₂Cu precipitates in the process of cooling. The amount of precipitation is determined by the content of Cu and the final annealing temperature.

If annealing at the same temperature, the larger the amount of Cu, the greater the amount of precipitation. In the case of the same amount of Cu, at a temperature at which sufficient diffusion occurs, the lower the annealing temperature, the greater the amount of precipitation.

The high temperature strength is improved if making the amount of addition of Cu increase. However, if the amount of Cu becomes larger, the amount of precipitation of Ti₂Cu becomes larger and the amount of solute Cu is reduced, so the high temperature strength falls. Further, if the amount of precipitation of Ti₂Cu is large, the grain growth is suppressed and fine grains result, so the cold workability falls.

That is, to obtain a certain extent or more of high temperature strength without causing a drop in cold workability, instead of increasing the amount of Cu, it is necessary to add other solid solution strengthening elements. The inventors discovered that by adding Sn while keeping down the amount of Cu, the precipitation of Ti₂Cu is suppressed and the high temperature strength is improved even at a relatively low heat treatment temperature and thereby decided to add Sn.

Furthermore, the content of oxygen, which causes the room temperature ductility to fall, is kept low and a cold workability on a par with pure titanium was secured.

A high heat oxidation resistance of over 600° C. is obtained by addition of Si and Nb.

Si forms silicide on the surface and thereby forms a barrier layer against oxidation when exposed to a high temperature. As a result, diffusion of oxygen to the inside of the titanium is suppressed, so excellent oxidation resistance is obtained.

Furthermore, by adding Nb, the oxidation resistance at a temperature exceeding 800° C. is improved. Nb dissolves a in the oxide film of the titanium. Titanium is tetravalent, while Nb is pentavalent, so if Nb dissolves in the oxide film of the titanium, the atomic vacancy concentration of oxygen in the oxide film of the titanium falls and diffusion of oxygen in the oxide film is suppressed.

The oxidation of titanium is a form of oxidation called “inward diffusion” wherein oxygen diffuses inward through the oxide film and bonds with titanium on the interface of oxide film and titanium substrate. Therefore, if diffusion of oxygen is suppressed, oxidation is suppressed.

Addition of a suitable amount of Nb is effective for raising the strength at high temperature, but has no effect on the cold workability. That is, if adding a suitable amount of Nb to the Ti—Cu—Sn—Si alloy, there is almost no effect on the cold workability and titanium alloy with an elevated high temperature strength and an excellent oxidation resistance can be obtained.

The titanium alloy of the present invention is excellent in high temperature strength and cold workability in particular near 800° C. and is excellent in oxidation resistance near 800° C.

The high temperature strength of the titanium alloy of the present invention is at least 1.5 times that of the 0.2% proof stress in the rolling direction at 800° C. of JIS class 2 commercially pure titanium, that is, 18N/mm² or more, so this contributes to the ability of exhaust system parts to handle high temperatures. The superiority becomes clear.

If the 0.2% proof stress at 800° C. is 18N/mm² or more, the muffler temperature of the vehicle during operation generally will rise up to 800° C. Even when up-down vibration etc. at the time of vehicle operation causes force to be applied to the muffler, the muffler is resistant to deformation. As a result, the degree of freedom in muffler design is increased.

For the indicator of cold workability, the elongation at fracture at the time of a tensile test at room temperature is generally used. Regarding the cold workability which is required when producing exhaust system parts, the elongation at fracture in the rolling direction at room temperature is at least the same 23% or more as pure titanium JIS class 2 (definition of elongation of JIS class 2 in JIS H4600, H4635).

If the elongation at fracture is equal to or better than that of the JIS class 2, the experience and know how in various cold working operations of users using the JIS class 2 material can be utilized fully as they are. For this reason, users can easily study production of the present invention material on actual industrial production lines and, as a result, easily incorporate it into industrial production lines now in operation where as much operating time as possible is desired to be secured.

For the indicator of the oxidation resistance, the increase in oxidation due to heating at 800° C. for 200 hours is used. If the increase in mass by oxidation is 65 g/m² or less, the growth of the surface oxidation layer due to the inward diffusion control of oxygen is substantially saturated and the thickness is maintained at one where almost no peeling of the surface oxide layer occurs.

Next, the reasons for limitation of the composition of ingredients of the titanium alloy material of the present invention will be explained.

If the amount of addition of Cu is less than 0.5%, the amount of Cu which forms a solid solution in the titanium alloy becomes smaller, so the 0.2% proof stress at 800° C. will not become 18N/mm² or more.

If the amount of addition of Cu is greater than 1.5%, the precipitation of Ti₂Cu becomes greater, the grain growth is suppressed, and fine grains result, so the elongation in the rolling direction at room temperature does not reach 23%. Further, Ti₂Cu precipitates preferentially at the grain boundaries resulting in a size and mode whereby Ti₂Cu does not contribute much to high temperature strength. As a result, the 800° C. 0.2% proof stress does not reach 18N/mm².

If the amount of addition of Sn is less than 0.5%, the amount of Sn which forms a solid solution in the titanium alloy becomes smaller, so the 0.2% proof stress at 800° C. will not become 18N/mm² or more. If the amount of addition of Sn is greater than 1.5%, twinning deformation of titanium is suppressed at room temperature, the cold workability deteriorates, and the elongation in the rolling direction at room temperature does not reach 23%.

If the total of the contents of Cu and Sn is less than 1.4%, the amounts of Cu and Sn which form solid solutions in the titanium alloy become smaller, so the 0.2% proof stress at 800° C. will not become 18N/mm² or more.

If the total of the contents of Cu and Sn exceeds 2.7%, the cold workability deteriorates and the elongation in the rolling direction does not reach 23%.

If the amount of addition of Si is 0.1% or less, the increase in mass by oxidation at continuous oxidation at 800° C. for 200 hours will not become 65 g/m² or less.

If the amount of addition of Si is greater than 0.6%, the effect of suppression of the increase of oxidation becomes saturated. Furthermore, twinning deformation of titanium is suppressed at room temperature, the cold workability deteriorates, and the elongation in the rolling direction at room temperature fails to reach 23%.

According to JIS H4600, the impurity levels of Si etc. in a titanium alloy are defined as being, in terms of elements alone, 0.10% or less.

Due to the above, the amount of addition of Si is made over 0.1% to not more than 0.6%. The more preferable amount of addition of Si is 0.3 to 0.6%.

The titanium alloy of the present invention (2) further contains, by mass %, Nb: 0.1 to 1.0%. If Nb is added compositely with Si, the high temperature oxidation resistance is remarkably improved. To obtain the effect of improvement of the oxidation resistance, Nb has to be added in an amount of 0.1% or more. Even if adding Nb in over 1.0%, the effect of improvement of the oxidation resistance becomes saturated, so the upper limit of the amount of addition is made 1.0%.

The present inventions (3) and (4) relate to the method of production of sheet which is extensively used in particular in exhaust systems of automobiles.

The present invention (3) provides a preferable method of production of titanium alloy sheet comprising hot rolling the titanium alloy material of the present invention (1) or (2), then cold rolling it, and after that final annealing it, characterized by performing the final annealing at 750 to 830° C. This is a condition aiming at increasing the amount of solid solution Cu as much as possible from the viewpoint of improvement of the cold workability and high temperature strength.

Even if performing annealing or other heat treatment outside of this temperature range, the titanium alloy sheet which is produced from the titanium alloy material of the present invention (1) or (2) has excellent oxidation resistance and cold workability. However, by annealing in this temperature range, the cold workability is further improved.

750 to 830° C. is the temperature at which the amount of formation of Ti₂Cu is small and the amount of Cu forming a solid solution in the α phase becomes large. Accordingly, by annealing in this temperature region, it is particularly possible to improve the high temperature strength.

Note that, if Ti₂Cu is produced during the cooling after annealing, the precipitation strengthening etc. due to this is believed to detract from the effect of improvement of the ductility by the annealing. However, the speed of precipitation of Ti₂Cu is extremely slow. With a cooling speed of the extent of air-cooling or furnace cooling, Ti₂Cu is never formed to an extent whereby the annealing effect ends up being impaired.

Further, the present invention (4) is a method of production of a titanium alloy sheet which comprises the steps of hot rolling the titanium alloy material of the present invention (1) or (2), then annealing the hot rolled sheet, next cold rolling it, and after that performing the final annealing.

If annealing the titanium alloy once at 750 to 830° C., even if later cold working it and again annealing it at 750° C. or less, since Ti₂Cu precipitates slowly, almost no Ti₂Cu is produced within the actual heat treatment time. As a result, it is possible to maintain the Cu which forms a solid solution in the α phase in large amounts. That is, if performing the final annealing before the cold rolling (hot rolled sheet annealing) at 750 to 830° C., even if performing the final annealing after the cold rolling at 750° C. or less, it is possible to maintain the Cu which forms a solid solution in the a phase in large amounts.

The present invention (4) applies this method of production. The final annealing temperature after the cold rolling is made 650 to 750° C. so that strain is sufficiently removed and the material softened and so that the crystal grain size does not become too fine and coarsening does not result.

The present invention (5) is an exhaust system which uses the titanium alloy material of the present invention (1) or (2). The titanium alloy material of the present invention has a workability and weldability based on the JIS class 2 commercially pure titanium, so methods based on the JIS class 2 commercially pure titanium may be used for melting, rolling, and forming. Further, cold rolled and annealed sheet may be bent into a pipe shape and welded by TIG welding and then the different parts welded on so as to obtain an exhaust system.

Note that, even an exhaust system which uses a muffler which is provided with a catalyst and thereby has both the functions of a catalyst device and the functions of a muffler is of course included in the scope of the present invention so long as it is an exhaust system wherein one or more of the exhaust manifold, exhaust pipe, and muffler provided with the catalyst are comprised of the titanium alloy of the present invention (1) or (2).

### EXAMPLE 1

Below, examples will be given to explain the constitution and actions and effects of the present invention more specifically.

A titanium material of a composition which is shown in Table 1 was melted by a vacuum arc remelting furnace (hereinafter referred to as “VAR”) and hot forged to a slab. This was heated to 860° C., then was hot rolled by a continuous hot rolling mill to a strip of a thickness of 3.5 mm. The oxide scale of this hot rolled strip was removed by shot blasting and pickling, then the strip was cold rolled to a thickness of 1 mm, then was vacuum annealed at 770° C. for 5 hours followed by furnace cooling (final annealing) to obtain a titanium alloy sheet.

From the obtained titanium alloy sheet, JIS No. 13B test pieces were cut and tested at room temperature by a tensile test. Further, a high temperature tensile test was performed at 800° C. based on JIS G0567. In a high temperature oxidation test, a 20 mm×20 mm test piece was polished at its surfaces and ends by #400 sandpaper, then exposed at 800° C. temperature in the atmosphere for 200 hours. The change in mass between before and after the test was measured and the increase in mass by oxidation per unit cross-sectional area was found.

The measurement results are shown in Table 1.

TABLE 1

| | | | | | | | Room temp. | High temp. | Increase by | |
|---|---|---|---|---|---|---|---|---|---|---|
| | | | | | | | elongation | strength | oxidation | |
| | Ingredients | | | | | | in the Rolling | (proof stress) | at 800° C. | |
| | mass % | | | | | | direction | at 800° C. | for 200 h | in mass |
| No. | Cu | Sn | Si | Nb | O | Cu + Sn | % | N/mm² | g/m² | Remarks |
| 1 | 0.8 | 0.7 | 0.5 | — | 0.09 | 1.5 | 33 | 19 | 51.4 | Inventions |
| | | | | | | | | | | (1), (3) |
| 2 | 1.0 | 0.8 | 0.4 | — | 0.06 | 1.8 | 31 | 20 | 55.9 | Inventions |
| | | | | | | | | | | (1), (3) |
| 3 | 1.1 | 1.0 | 0.3 | — | 0.05 | 2.1 | 29 | 23 | 57.2 | Inventions |
| | | | | | | | | | | (1), (3) |
| 4 | 1.2 | 1.2 | 0.2 | — | 0.04 | 2.4 | 27 | 26 | 59.6 | Inventions |
| | | | | | | | | | | (1), (3) |
| 5 | 0.5 | 1.4 | 0.5 | 0.3 | 0.03 | 1.9 | 26 | 21 | 36.3 | Inventions |
| | | | | | | | | | | (2), (3) |
| 6 | 1.0 | 1.0 | 0.4 | 0.5 | 0.06 | 2.0 | 29 | 22 | 34.2 | Inventions |
| | | | | | | | | | | (2), (3) |
| 7 | 1.5 | 1.0 | 0.3 | 0.7 | 0.05 | 2.5 | 29 | 27 | 33.9 | Inventions |
| | | | | | | | | | | (2), (3) |
| 8 | 1.0 | 0.5 | 0.2 | 0.8 | 0.05 | 1.5 | 35 | 46 | 36.5 | Inventions |
| | | | | | | | | | | (2), (3) |
| 9 | 1.7 | 0.1 | 0.2 | — | 0.04 | 1.8 | 36 | 17 | 58.7 | Comp. ex. |
| 10 | 0.2 | 1.4 | 0.2 | — | 0.05 | 1.6 | 33 | 15 | 61.2 | Comp. ex. |
| 11 | 0.5 | 0.5 | 0.5 | — | 0.05 | 1.0 | 42 | 11 | 52.3 | Comp. ex. |
| 12 | 1.1 | 1.0 | 0.0 | — | 0.05 | 2.1 | 30 | 22 | 115.8 | Comp. ex. |
| 13 | 1.0 | 0.5 | 0.8 | — | 0.05 | 1.5 | 22 | 18 | 50.8 | Comp. ex. |
| 14 | 1.7 | 0.5 | 0.2 | — | 0.05 | 2.2 | 21 | 23 | 59.8 | Comp. ex. |
| 15 | 1.4 | 1.3 | 0.3 | — | 0.13 | 2.7 | 22 | 24 | 58.1 | Comp. ex. |
| 16 | 1.5 | 1.5 | 0.2 | — | 0.04 | 3.0 | 20 | 26 | 59.7 | Comp. ex. |

| | | | | | |
|---|---|---|---|---|---|
| 17 | 3Al—2.5V | 19.5 | 28 | 292.2 | Comp. ex. |

Nos. 1 to 4 are examples of the present invention (1). In each case, the 0.2% proof stress in the rolling direction at 800° C. was 1.5 times that of JIS class 2 commercially pure titanium, that is, 18N/mm² or more, and the elongation in the rolling direction at room temperature was 23% or more. The increase in mass by oxidation with heating at 800° C. for 200 hours was 65 g/m² or less. Due to the above, it could be confirmed that the examples had sufficient cold workability, sufficient proof stress at high temperature, and excellent oxidation resistance at a high temperature.

Nos. 5 to 8, to which Nb was added, are examples of the present invention (2). Elongation at room temperature and the proof stress at 800° C. were equivalent to Nos. 1 to 4. It could be confirmed that the increases in mass by oxidation after heating at 800° C. for 200 hours were reduced compared with Nos. 1 to 4 and the oxidation resistances were improved.

On the other hand, in No. 9, where the amount of Sn was small, No. 10, where the amount of Cu was small, and No. 11, where the amounts of Cu+Sn were small, the 0.2% proof stress at 800° C. failed to reach 18N/mm².

In No. 12, where Si and Nb were not added, the increase in mass by oxidation at 800° C. was remarkably high and the oxidation resistance was poor as a result.

In No. 13, where the content of Si exceeded the upper limit of the present invention, and in No. 14, where the amount of Cu exceeded the upper limit of the present invention, the elongations at room temperature failed to satisfy the targeted value of 23%.

In No. 15, where the amount of oxygen exceeded the upper limit of the present invention, and No. 16, the amount of Cu+Sn exceeded the upper limit of the present invention, as well, the elongations at room temperature were lower than the targeted value of 23%.

No. 17, which contained Al: 3 mass % and V: 2.5 mass %, had a high 0.2% proof stress at 800° C. and was superior in terms of high temperature strength, but was insufficient in ductility at room temperature. Further, the increase in mass by oxidation at 800° C. was over 65 g/m², so there was not sufficient oxidation resistance.

### EXAMPLE 2

A titanium material of a composition which is shown in Table 2 was melted by a VAR and hot forged to a slab. This was heated to 860° C., then was hot rolled by a hot continuous rolling mill to a strip of a thickness of 3.5 mm. This hot rolled strip was continuously annealed at 800° C. for 2 minutes followed by air-cooling (hot rolled sheet annealing), furthermore the oxide scale was removed by shot blasting and pickling, then the strip was cold rolled to a thickness of 1 mm, then the strip was vacuum annealed at 730° C. for 4 hours followed by furnace cooling (final annealing) to obtain a titanium alloy sheet.

From the obtained titanium alloy sheet, JIS No. 13B test pieces were cut and tested at room temperature by a tensile test. Further, a high temperature tensile test was performed at 800° C. based on JIS G0567. In a high temperature oxidation test, a 20 mm×20 mm test piece was polished at its surfaces and ends by #400 sandpaper, then exposed at 800° C. temperature in the atmosphere for 200 hours. The change in mass between before and after the test was measured and the increase in mass by oxidation per unit cross-sectional area was found.

The measurement results are shown in Table 2.

TABLE 2

| | | | | | | | Room temp. | High temp. | Increase by | |
|---|---|---|---|---|---|---|---|---|---|---|
| | | | | | | | elongation | strength | oxidation | |
| | Ingredients | | | | | | in the | (proof stress) | at 800° C. | |
| | mass % | | | | | | Elongation | at 800° C. | for 200 h | |
| No. | Cu | Sn | Si | Nb | O | Cu + Sn | % | N/mm² | g/m² | Remarks |
| 18 | 0.8 | 0.8 | 0.5 | — | 0.06 | 1.6 | 33 | 19 | 50.4 | Inventions |
| | | | | | | | | | | (1), (4) |
| 19 | 1.0 | 1.0 | 0.4 | — | 0.06 | 2.0 | 29 | 22 | 54.4 | Inventions |
| | | | | | | | | | | (1), (4) |
| 20 | 1.2 | 1.2 | 0.3 | — | 0.05 | 2.4 | 27 | 26 | 56.2 | Inventions |
| | | | | | | | | | | (1), (4) |
| 21 | 1.4 | 1.2 | 0.2 | — | 0.04 | 2.6 | 27 | 27 | 58.8 | Inventions |
| | | | | | | | | | | (1), (4) |
| 22 | 1.0 | 1.0 | 0.5 | 0.3 | 0.03 | 2.0 | 29 | 22 | 34.6 | Inventions |
| | | | | | | | | | | (2), (4) |
| 23 | 0.8 | 0.8 | 0.4 | 0.5 | 0.05 | 1.6 | 33 | 19 | 35.7 | Inventions |
| | | | | | | | | | | (2), (4) |
| 24 | 1.3 | 0.8 | 0.3 | 0.7 | 0.04 | 2.1 | 30 | 21 | 37.3 | Inventions |
| | | | | | | | | | | (2), (4) |
| 25 | 1.5 | 0.5 | 0.2 | 0.8 | 0.03 | 2.0 | 34 | 22 | 38.6 | Inventions |
| | | | | | | | | | | (2), (4) |

Nos. 18 to 21 are examples of the present invention (1), while Nos. 22 to 25 are examples of the present invention (2). In each case, the 0.2 proof stress in the rolling direction at 700° C. was 1.5 times that of JIS class 2 commercially pure titanium, that is, 18N/mm² or more, and the elongation in the rolling direction at room temperature was 23% or more. The increase in mass by oxidation with heating at 800° C. for 200 hours was 60 g/m² or less. Due to the above, it could be confirmed that the examples had sufficient cold workability at room temperature, sufficient proof stress at a high temperature, and excellent oxidation resistance at a high temperature.

In Nos. 22 to 25, to which Nb was added, the elongation at room temperature and the proof stress at 800° C. were of the same extent as Nos. 18 to 21. The increases in mass by oxidation after heating at 800° C. for 200 hours were reduced compared with Nos. 18 to 21. It could be confirmed that the oxidation resistance was improved.

### EXAMPLE 3

Flat sheets were sampled from the intermediate product when producing the materials of Test Nos. 1 and 6 of Table 1, that is, hot rolled strips of 3.5 mm thickness. The hot rolled strips were annealed under the conditions which are shown in Table 3, furthermore the oxide scale was removed by shot blasting and pickling, then the strips were cold rolled to a thickness of 1 mm, and after that the cold rolled strips were annealed (final annealing) under the conditions shown in Table 3 to obtain a titanium alloy sheet.

From the obtained titanium alloy sheet, JIS No. 13B test pieces were cut and tested at room temperature by a tensile test. Further, a high temperature tensile test was performed at 800° C. based on JIS G0567. In a high temperature oxidation test, a 20 mm'20 mm test piece was polished at its surfaces and ends by #400 sandpaper, then exposed at 800° C. temperature in the atmosphere for 200 hours. The change in mass between before and after the test was measured and the increase in mass by oxidation per unit cross-sectional area was found.

The measurement results are shown in Table 3.

TABLE 3

| | | | | Room temp. | High temp. | Increase by | |
|---|---|---|---|---|---|---|---|
| | | Hot rolled | Cold rolled | elongation | strength | oxidation | |
| | | sheet | sheet | in the | (proof stress) | at 800° C. | |
| | | annealing | annealing | Elongation | at 800° C. | for 200 h | |
| No. | Sample | conditions | conditions | % | N/mm² | g/m² | Remarks |
| 26 | No. 1 | 770° C., 3 min. | 730° C., 8 h | 34 | 21 | 51.3 | Inventions |
| | | | | | | | (1), (4) |
| 27 | No. 1 | | 710° C., 10 h | 33 | 21 | 51.5 | Inventions |
| | | | | | | | (1), (4) |
| 28 | No. 6 | 800° C., 2 min. | 700° C., 8 h | 30 | 24 | 34.1 | Inventions |
| | | | | | | | (1), (4) |
| 29 | No. 6 | | 690° C., 10 h | 29 | 24 | 34.3 | Inventions |
| | | | | | | | (2), (4) |
| 30 | No. 1 | 640° C., 20 min. | 740° C., 8 h | 33 | 19 | 51.4 | Invention |
| | | | | | | | (1) |
| 31 | No. 6 | 860° C., 1 min. | 700° C., 8 h | 29 | 22 | 34.2 | Invention |
| | | | | | | | (2) |
| 32 | No. 6 | 750° C., 2 min. | 640° C., 10 h | 28 | 22 | 34.3 | Invention |
| | | | | | | | (2) |

Nos. 26 to 29 are examples where the hot rolled sheet annealing and final annealing of the present invention (4) are performed.

In Nos. 30 to 32, the conditions of either the hot rolled sheet annealing or the final annealing were outside the scope prescribed in the present invention (4). In Nos. 30 to 32, the titanium alloy of the present invention was sufficiently provided with the targeted quality.

In Nos. 26 to 29, due to the hot rolled sheet annealing at the temperature shown in the present invention (4), large amounts of the Cu and Sn, which form solid solutions in the a phase, are maintained. In each of Nos. 26 to 29 as well, if comparing the same compositions of ingredients in Nos. 30 to 32 (Sample No. 1 or 6), it was confirmed that the high temperature strength at 800° C. was improved.

### EXAMPLE 4

A titanium alloy of a composition of ingredients which is shown in Table 1, No. 6 was melted by a VAR and hot forged to a slab. This was heated to 860° C., then was hot rolled by a hot continuous rolling mill to a strip of a thickness of 4 mm. This hot rolled strip was annealed at 780° C. for 5 minutes followed by air-cooling by continuous annealing (hot rolled sheet annealing), furthermore the oxide scale was removed by shot blasting and pickling, the strip was cold rolled to a thickness of 1 mm, then the strip was heat treated at 690° C. for 8 hours to obtain a titanium alloy sheet.

The obtained titanium alloy sheet was cut to a width of 120 mm and used to produce a welded pipe of an outside diameter of 38 mm. This was done by bending, then welded by TIG welding to produce the welded pipe. The process of production of the welded pipe was the same as the case of production using a sheet based on JIS class 2 commercially pure titanium.

A 60° conical cone was pushed into the end of the welded pipe to expand it to 1.3 times the initial diameter. At this time, no cracks occurred at the weld zone, so the expansion characteristics were good. Further, when the welded pipe was bent 90° by a radius of 90 mm, no cracks or wrinkles resulted.

### INDUSTRIAL APPLICABILITY

The titanium alloy material of the present invention is high in high temperature strength, superior in oxidation resistance, and also excellent in ductility at room temperature and enables manufacture of welded pipes as easily as a conventional pure titanium material. Therefore, it can be utilized for the main mufflers of four-wheeled vehicles, motorcycles, and other automobiles of course and also for exhaust manifolds, exhaust pipes, catalyst devices, mufflers, and other exhaust system members. As a result, four-wheeled vehicles, motorcycles, and other automobiles are becoming lighter in weight, so the contribution to industry is extremely remarkable.

1. A heat resistant titanium alloy material for exhaust system parts which is excellent in oxidation resistance characterized by containing, by mass %,
Cu: 0.5 to 1.5%,
Sn: 0.5 to 1.5%,
Si: over 0.1% to not more than 0.6%, and
O: 0.1% or less,
a total of the contents of Cu and Sn being 1.4 to 2.7%, and
having a balance of Ti and unavoidable impurities.

2. A heat resistant titanium alloy material for exhaust system parts which is excellent in oxidation resistance of claim 1 characterized by further containing, by mass %, Nb: 0.1 to 1.0%.

3. A method of production of a heat resistant titanium alloy sheet for exhaust system parts which is excellent in oxidation resistance characterized by hot rolling a titanium alloy material of claim 1 or 2), then cold rolling it, and after that annealing it at 750 to 830° C.

4. A method of production of a heat resistant titanium alloy sheet for exhaust system parts which is excellent in oxidation resistance characterized by hot rolling a titanium alloy material of claim 1 or 2, then annealing it at 750 to 830° C., next cold rolling it, and after that annealing it at 650 to 750° C.

5. An exhaust system provided with an exhaust manifold, exhaust pipe, catalyst device, and muffler, said exhaust system characterized by using a heat resistant titanium alloy material for exhaust system parts which is excellent in oxidation resistance of claim 1 or 2 for one or more of the exhaust manifold, exhaust pipe, catalyst device, and muffler.
